(19) United States
(12) Patent Application Publication
(10) Pub. No.: US 2003/0093910 A1
(43) Pub. Date: May 22, 2003

(54) Straight line template

(76) Inventor: Kun-Sheng Chang, Lu-Chou City (TW)

Correspondence Address: DELLETT AND WALTERS, 310 S.W. FOURTH AVENUE, SUITE 1101, PORTLAND, OR, 97204, US

(21) Appl. No.: 09/995,986

(22) Filed: Nov. 19, 2001

(51) Int. Cl. B43L 7/00

(52) U.S. Cl. 33/566

(57) ABSTRACT

A straight line template has a piece of plate with an array of bulged members arranged equal-spaced in both rows and columns on a front side thereof. The space between the adjacent rows or columns of the bulged members is formed as a layout area for drawing horizontal or vertical straight lines therealong. When a user utilizes a writing implement to draw on a sheet of paper covered on the front side of the straight line template, a pen point of the writing implement is pressed on the paper and forced towards the layout area to stroke a straight line on the paper along the layout area in a horizontal or a vertical coordinate of the plane plate. Therefore horizontal and vertical straight lines are easily drawn on the paper by utilizing the straight line template without any additional tools.

### BACKGROUND OF THE INVENTION

1. Field of the Invention

The present invention relates to a straight line template utilized as an implement for drawing horizontal and vertical straight lines on a sheet of paper without any additional tool.

2. Description of Related Art

People normally utilize a writing implement and a straightedge rule to draw straight lines on a sheet of paper. However, if a table frame with a plurality rows and columns needs to be drawn on the paper, people have to use the straightedge rule and set squares simultaneously to lay out a plurality of horizontal straight lines and vertical straight lines on the paper. Because the parallel horizontal straight lines and parallel vertical straight lines are difficult to be drawn on the paper precisely by means of the conventional straightedge rule and set squares, the traditional method has shortcomings that the procedure of drawing a table frame is too complex, the time cost on drawing of the table frame is too long and necessary instruments for drawing the table frame are also complex.

Therefore, it is an objective of the invention to provide a straight line template to mitigate and/or obviate the aforementioned problems.

### SUMMARY OF THE INVENTION

The main object of the present invention is to provide a straight line template having a rectangular plate with an array of bulged members formed on a front side thereof and arranged equal-spaced in both rows and columns respectively extending along horizontal and vertical coordinates thereof. The space between the adjacent rows or columns of the bulged members is formed as a layout area for drawing horizontal and vertical straight lines therealong. When a user utilizes a writing implement to draw on a sheet of paper covered on the front side of the straight line template, a point of the writing implement is pressed on the paper and forced towards the layout area to stroke a straight line on the paper along the layout area in a horizontal or a vertical coordinate of the plane plate. In such a way, the horizontal and vertical straight lines are able to be directly laid out on the paper by utilizing the straight line template of the invention without any additional tools.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a straight line template in accordance with the invention;

FIG. 2 is an enlarged partial perspective view of the first embodiment of the straight line template in accordance with the invention;

FIG. 3 a schematic view of the first embodiment showing a writing implement utilized to draw a straight line on a sheet of paper in cooperation with the straight line template of the first embodiment of the invention;

FIG. 4 is a schematic view of drawing straight lines in cooperation with the straight line template;

FIG. 5 is an enlarged partial perspective view of a second embodiment of the straight line template in accordance with the invention; and

FIG. 6 is a schematic view of the second embodiment showing the writing implement utilized to draw a straight line on the sheet of paper in cooperation with the straight line template of the second embodiment of the invention

### DETAILED DESCRIPTION OF THE PREFERRED EMBODIMENT

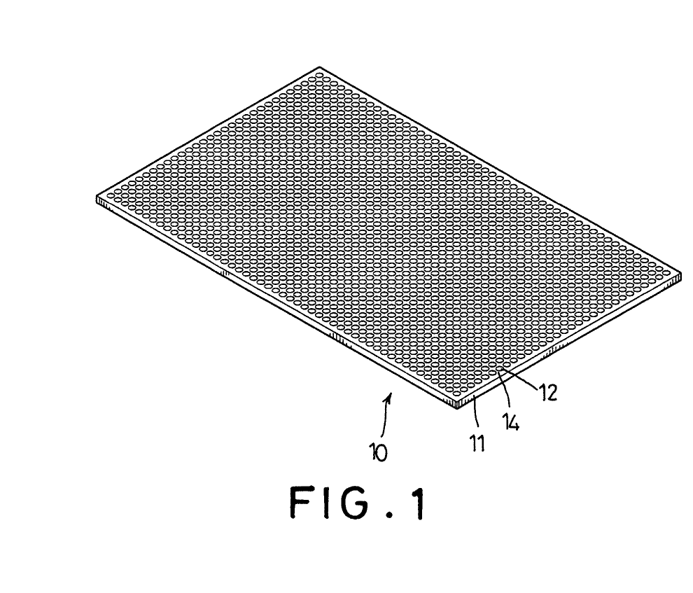

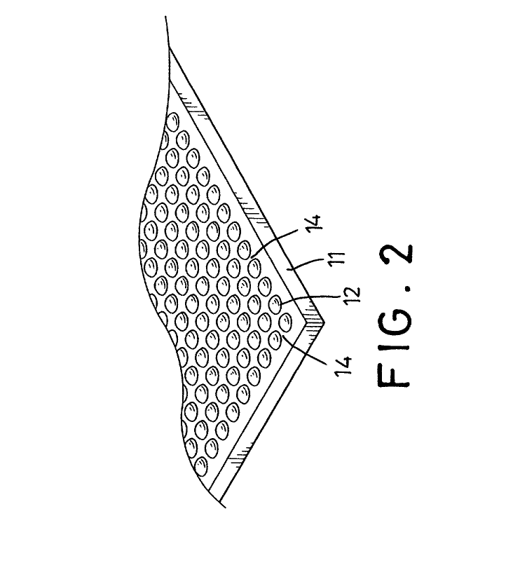

As shown in FIGS. 1 and 2, a straight line template (10) in accordance with the invention has a rectangular plate (11), which is optionally sized according to the standard sizes of the office papers, such as A4 and B4 etc.

An array of bulged members are formed on a front side of the plane plate (11) and arranged equal-spaced in both rows and columns respectively extending along horizontal and vertical coordinates of the plane plate (11). Particularly, the bulged members are respectively formed with blunt tip ends thereof.

The space between the adjacent rows and columns of the bulged members is formed as a layout area (14) having a minimum width predetermined about 1 mm.

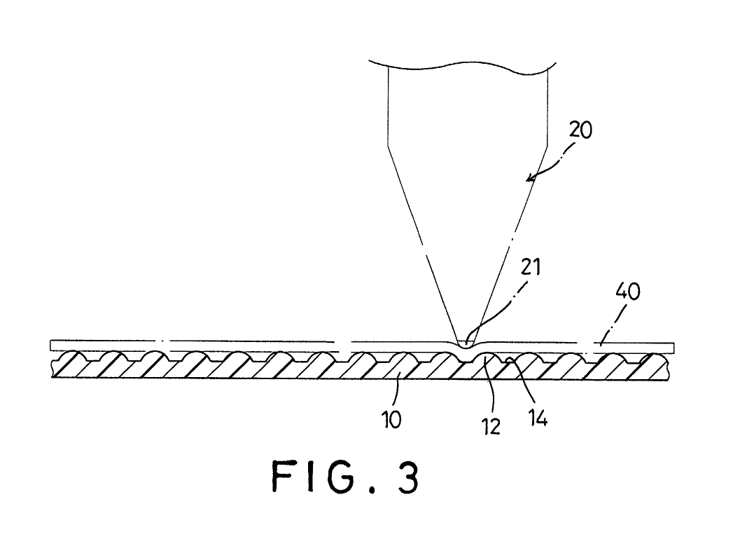

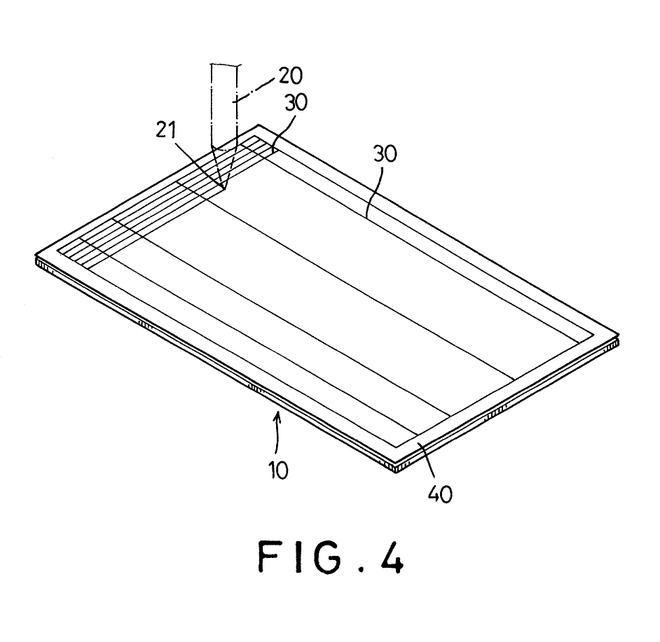

With reference to FIGS. 3 and 4, a sheet of paper (40) with at least one edge thereof flush with an edge of the plane plate (11) is laid on the front side of the straight line template (10). When a user utilizes a writing implement (20) to draw on the paper (40), a point (21) of the writing implement (20) is pressed on the paper (40) and forced towards the layout area (14) to stroke a straight line on the paper (40) along the layout area (14) in the horizontal or vertical coordinate of the plane plate (11). In such a way, the horizontally and vertically extending straight lines are able to be drawn on the paper (40) by utilizing of the straight line template (10).

As shown in FIGS. 1 to 4, in a first embodiment of the invention, the bulged members are formed as semispherical members (12).

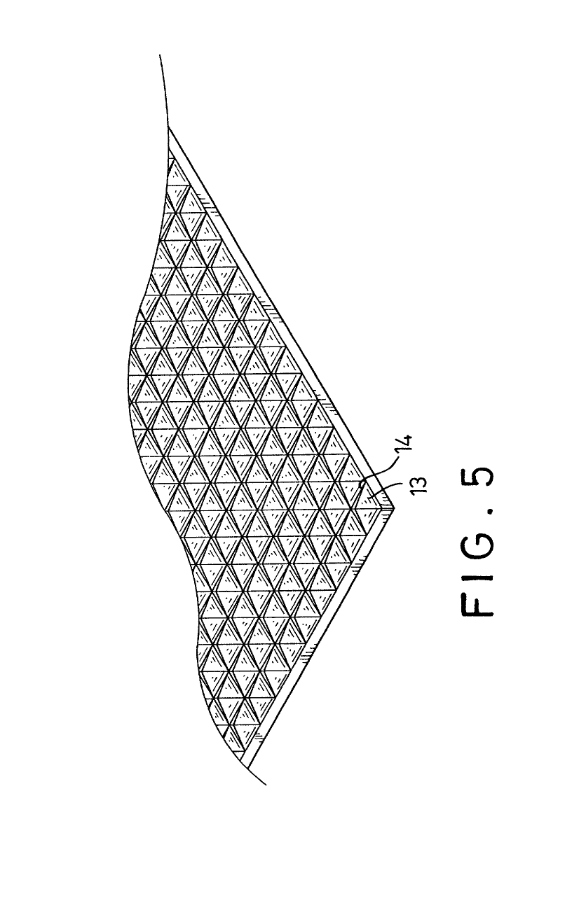

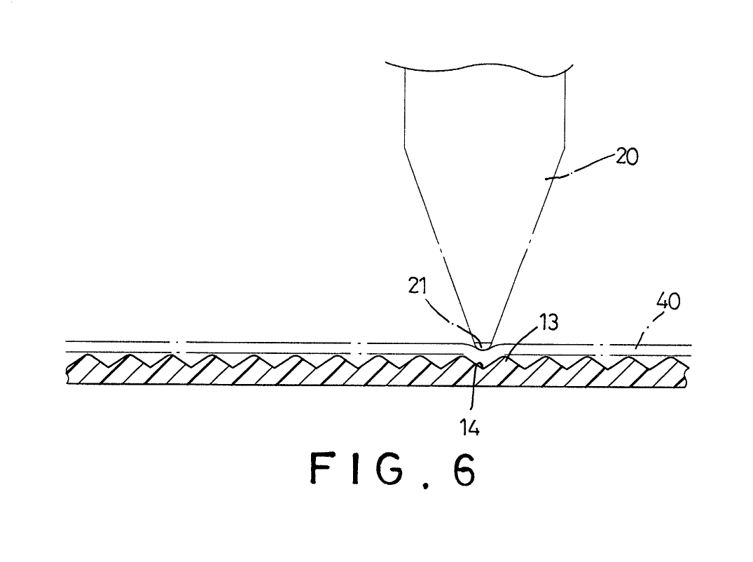

As shown in FIGS. 5 and 6, in a second practicable embodiment of the invention, the bulged members are formed as pyramidical members (13).

The straight line template (10) of the invention has following advantages:

1. The straight line template (10) is easily utilized to draw multiple horizontal and vertical straight lines on the paper (40) laid on the front side thereof without any additional tool.

2. Due to the blunt tip ends of the bulged members, the paper (40) laid on the front side of the straight line template (10) will not be penetrated by the bulged members.

3. The straight line template (10) is formed in a simple structure which is portable for students, etc.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A straight line template having
a rectangular piece of plane plate (11);
an array of bulged members formed on a front side of the plane plate (11) and arranged equal-spaced in rows and columns extending along horizontal and vertical coordinates of the plane plate (11); and
a layout area (14) formed between adjacent rows and columns of the bulged members.

2. The straight line template as claimed in claim 1, wherein the bulged members are respectively formed with blunt tip ends.

3. The straight line template as claimed in claim 2, wherein the bulged members are formed as semispherical members (12).

4. The straight line template as claimed in claim 2, wherein the bulged members are formed as pyramidical members (13).
